(19) United States
(12) Patent Application Publication
(10) Pub. No.: US 2004/0050987 A1
(43) Pub. Date: Mar. 18, 2004

(54) Mobile jaw crusher assembly

(76) Inventor: Robert R. Rossi JR., Charlotte, NC (US)

Correspondence Address: DORITY & MANNING, P.A., POST OFFICE BOX 1449, GREENVILLE, SC, 29602-1449, US

(21) Appl. No.: 10/660,046

(22) Filed: Sep. 11, 2003

Related U.S. Application Data
(63) Continuation-in-part of application No. 10/245,482, filed on Sep. 17, 2002.

(51) Int. Cl. B02C 21/02

(52) U.S. Cl. 241/101.77

(57) ABSTRACT

A mobile jaw crusher assembly for crushing objects is provided. The assembly includes a frame and a first crushing member that is configured to be moved and at least partially rotated by a vehicle. The first crushing member is configured to be attached to the vehicle. A second crushing member is also present and faces the first crushing member. The first and second crushing members define a crushing chamber that is used for crushing objects. The second crushing member is configured to be moved and at least partially rotated by the vehicle. A guard may be provided and may be configured to block an inlet opening of the frame and prevent objects from exiting the frame through the inlet opening. Additionally or alternatively to the guard, a dust suppression system may be provided in order to reduce the amount of dust brought about by the crushing operation.

### CROSS-REFERENCE TO RELATED APPLICATIONS

The present application is a Continuation-In-Part (CIP) of U.S. patent application Ser. No. 10/245,482 filed on Sep. 17, 2002, entitled “Mobile Jaw Crusher Assembly” whose inventor is Robert R. Rossi, Jr. application Ser. No. 10/245,482 is incorporated by reference herein in its entirety for all purposes.

### FEDERALLY SPONSORED RESEARCH OR DEVELOPMENT

N/A

### BACKGROUND

Jaw crushers are machines that typically are stationed at construction sites such as where buildings are being demolished or roads are being built or repaired. The jaw crushers are used to reduce rubble or other materials from a larger to a smaller size. Material from these constructions sites may be placed into the jaw crusher, crushed into a suitable size by the jaw crusher and a further processing machine, and then reused at this particular construction site. This allows for a quick, inexpensive supply of needed materials along with the reduction of waste to the environment.

Another important use of jaw crushers is in assisting in the cleaning up and the reduction of waste in our society. Jaw crushers may reduce objects from a larger to a smaller size in order to recycle and/or store waste material. Jaw crushers assist in recycling used concrete, asphalt, brick, cinder block, demolition debris, glass, and any other substances that are hard and brittle. Jaw crushers are also used for crushing rock and other natural substances. The recycling of these materials is an increasingly important aspect in the cleaning and preservation of our environment.

A typical jaw crusher uses a diesel/hydraulic system in order to operate. It is often the case that other pieces of machinery that work in conjunction with the jaw crusher to reduce material from a base size to the desired size also have their own diesel/hydraulic systems. For instance, a front end loader may load material into the jaw crusher, and a screening device may be present to reduce the size of the material that is ejected from the jaw crusher. Further, a conveyor system is commonly employed to transport material to and from the jaw crusher. In addition to the increased cost of running these separate systems, operation of such numerous diesel/hydraulic systems also negatively impacts the environment.

A jaw crusher includes a generally V-shaped crushing space that is formed between two crushing plates. Typically one of these plates is a fixed plate while the other plate is movable. It is common for an eccentric shaft to be provided on the jaw crusher. The movable plate is in communication with this eccentric shaft, and rotation of the eccentric shaft causes a corresponding movement of the movable plate. Material is placed into the upper portion of the crushing space. This material, for instance a stone, is then crushed between the two crushing plates by relative movement of the crushing plates. The broken material then falls due to gravity into a subsequently narrower portion of the crushing space and is likewise reduced in size. Upon exiting the crushing space from the jaw crusher, the material is reduced to a size smaller than that when previously inserted.

In a typical jaw crusher, the movable plate transfers a great quantity of energy in a short amount of time into the material that is crushed between the two crushing plates. This energy is transmitted into the stone or other material and concentrates locally in a weak portion or interior area of the stone. This local concentration of energy allows for the stone to be crushed between the two crushing plates.

Some jaw crushers are provided with a wedge adjusting mechanism that may be used to toggle the distance between the two crushing plates. Such an adjustment of the distance between the crushing plates is effected when the jaw crusher is turned off. Such an adjustment of the distance between the two crushing plates will allow for varying output sizes of material to be realized.

Problems have occurred in jaw crushers when they are utilized in crushing softer materials, for example asphalt. It is sometimes the case that these softer materials are not pulverized into smaller pieces, but are instead pressed into a smaller, harder piece. Such pressing of soft materials presents a problem because they may become adhesively connected to one of the crushing plates. In such a situation, the sticking of material onto one of the crushing plates may prevent operation of the jaw crusher. This situation requires stopping the jaw crusher and removal of the jammed object. Crushing material that contains clay or other softer materials may necessitate the stopping of the jaw crusher at occasional intervals in order to scrape out the compacted clay from corrugations that may be present on the crushing plate. The pivotal crushing plate of some jaw crushers may be rotated in an opposite direction in order to remove this adhesively connected material from the crushing plate. Upon removal of this material, the crushing plate may be again rotated in the forward direction to once again pulverize material.

A jaw crusher is also designed in order to crush harder materials. In fact, jaw crushers may crush materials that contain steel. It is sometimes the case that material that contains steel when crushed by a jaw crusher separates from the steel upon being crushed. An example of some material that may be crushed by a jaw crusher include: rock, rubble, stone, boulders, concrete, asphalt, brick, block, glass, demolition debris, and the like.

In some jaw crushers, the most efficient mode of operation of the jaw crusher is to keep the crushing chamber full of material. Material may be fed into the crushing chamber of the jaw crusher by, for instance, a front end loader.

Jaw crushers are typically positioned at single locations in a construction site. Other pieces of machinery must be used in order to provide material to the jaw crusher to be crushed. Additional equipment must be employed in order to remove the material that is ejected from the jaw crusher, and must be used to further process the material into a desired size. Additionally, further equipment may be required in order to transport the ejected material from the jaw crusher into a desired location. All of the equipment and/or systems used to transport material to and from the jaw crusher, in addition to further process the material, require a source of power. Also, these systems must be maintained and often operated by a user. Elimination of these systems would prove beneficial in that less energy, man power, and/or power sources would be needed to complete the process.

### SUMMARY

The present invention improves upon previous jaw crushers by providing for a mobile jaw crusher assembly that can be attached to a piece of construction equipment such as a front end loader. Additionally, the present invention also improves upon previous jaw crushers by providing for a single pass jaw crusher and a jaw crusher that is powered by the vehicle onto which it is attached. Such a configuration reduces the number of diesel/hydraulic systems that must be employed in the crushing of materials, along with a reduction in the amount of equipment that must be employed in reducing material to a desired size. Additionally, other benefits may be realized as described herein.

The present invention provides for a mobile jaw crusher assembly that is used for crushing objects. The mobile jaw crusher assembly includes a frame housing a first crushing member that is configured to be moved and at least partially rotated by a vehicle along with the frame. The frame defines an inlet and an outlet. The vehicle may be, for instance, a front-end loader, a crane, or an excavator. A second crushing member is also present and faces the first crushing member. The first and the second crushing members define a crushing chamber that is used for crushing objects. Objects are crushed by relative movement between the first and second crushing members. The second crushing member is also configured to be moved and at least partially rotated by the vehicle. Further, a guard is provided and is selectively positioned to block the inlet opening of the frame and prevent at least some of the objects from exiting the frame through the inlet opening. In an alternative exemplary embodiment of the present invention, in addition to or instead of the guard as previously mentioned, a spray jet is present and is attached to the frame. The spray jet may be used for suppressing dust brought about by the crushing of objects.

The present invention also provides for exemplary embodiments of the mobile jaw crusher assembly as discussed above where the guard includes a hinge that is configured to allow the guard to pivot with respect to the vehicle. Additionally, the mobile jaw crusher assembly may be provided with a guard that has a support frame that supports an elastomeric dampener, which can be configured with a plurality of curtains arranged in a crisscross pattern.

The present invention also provides for a mobile jaw crusher assembly as discussed above where the guard has a pair of clevises, each clevis having a pivot pin configured to allow the guard to pivot with respect to the vehicle. Further, the jaw crusher assembly may be configured as discussed above where the guard also has at least one cable that is configured for attachment to the vehicle. The cable is used for supporting the guard at a desired position.

Also provided for in accordance with the present invention is an exemplary embodiment of the mobile jaw crusher assembly as discussed above which further has a hydraulic cylinder that engages the guard and is used for positioning the guard.

The mobile jaw crusher assembly of the present invention may also be provided with a dust suppression system. This system may include a water tank that is configured for attachment to the vehicle, and a spray jet or jets that are attached to the frame. A water line may place these two components into fluid communication with one another, and a water pump may be used to force water through the water line and out of the spray jet in order to reduce dust brought about by the crushing of objects.

Various features and advantages of the invention will be set forth in part in the following description, or may be obvious from the description, or may be learned from practice of the invention.

### BRIEF DESCRIPTION OF THE DRAWINGS

FIG. 1 is a side elevation view of an exemplary embodiment of a mobile jaw crusher assembly in accordance with the present invention.

FIG. 2 is a side elevation view of the mobile jaw crusher assembly shown in FIG. 1. The drawing shows the mobile jaw crusher assembly being partially rotated, and objects being passed therethrough and crushed by the mobile jaw crusher assembly.

FIG. 3A is a side elevation view of an exemplary embodiment of a driving mechanism in accordance with the present invention. The driving mechanism is shown as including a first and second rubber tire that engage one another.

FIG. 3B is a side elevation view of an exemplary embodiment of a driving mechanism in accordance with the present invention. The driving mechanism is shown as including a drive pulley that engages a driven pulley to rotate an eccentric shaft.

FIG. 3C is a side elevation view of an exemplary embodiment of a driving mechanism in accordance with the present invention. The driving mechanism is shown as being a hydraulic motor that is directly coupled to an eccentric shaft.

FIG. 4 is a front elevation view of an exemplary embodiment of a mobile jaw crusher assembly in accordance with the present invention. The drawing shows the presence of hydraulic cylinders along with two angled guards being present on the mobile jaw crusher assembly.

FIG. 4A is a cross section view taken along line 4A of FIG. 4.

FIG. 5 is a side elevation view of an exemplary embodiment of a mobile jaw crusher assembly in accordance with the present invention. The mobile jaw crusher assembly is shown being attached to a front end loader and being positioned in order to have objects placed into the mobile jaw crusher assembly.

FIG. 6 is a side elevation view of the mobile jaw crusher assembly shown in FIG. 5. The drawing shows the front end loader lifting the mobile jaw crusher assembly and rotating the mobile jaw crusher assembly such that objects are crushed and deposited from the mobile jaw crusher assembly into a stock pile of crushed objects.

FIG. 7 is a partial cross section view of an exemplary embodiment of an eccentric shaft assembled into a frame and a shaft housing in accordance with one exemplary embodiment of the present invention.

FIG. 8 is a cross section view taken along line 8-8 of FIG. 7.

FIG. 9 is a cross section view taken along line 9-9 of FIG. 7.

FIG. 10A is a cross sectional view similar to FIG. 4A of an exemplary embodiment of a mobile jaw crusher assembly in accordance with the present invention. A guard is positioned so as to isolate a crushing chamber from a holding chamber.

FIG. 10B is another cross sectional view similar to FIG. 4A of the exemplary embodiment of the mobile jaw crusher assembly shown in FIG. 10A. Here the angled guard is positioned so that the crushing chamber is in communication with the hold chamber.

FIG. 11 is a side elevation view of a mobile jaw crusher assembly in accordance with the present invention. The mobile jaw crusher assembly has a guard pivotally attached to an arm of a vehicle, in this case an excavator, and held in position away from a frame of the mobile jaw crusher assembly by a cable.

FIG. 12 is a side elevation view of the mobile jaw crusher assembly shown in FIG. 11. This view shows the guard positioned so as to prevent objects from exiting the inlet opening of the mobile jaw crusher assembly.

FIG. 13 is a top plan view of an exemplary embodiment of the guard of the mobile jaw crusher assembly in accordance with the present invention. The guard includes a support frame that carries an elastomeric dampener.

FIG. 14 is a side elevation view of an exemplary embodiment of a hinge of the mobile jaw crusher assembly in accordance with the present invention.

FIG. 15 is a partial cross-sectional view taken along line 15-15 of FIG. 11.

FIG. 16 is a side elevation view of an exemplary embodiment of a mobile jaw crusher assembly in accordance with the present invention. Here the guard is positioned by a hydraulic cylinder that is attached to an arm of the vehicle, in this case an excavator.

FIG. 17 is a side elevation view of an exemplary embodiment of a mobile jaw crusher assembly in accordance with the present invention. A dust suppression system is present and includes a spray jet or jets attached to the mobile jaw crusher assembly, and a water tank and water pump configured on an excavator to which the mobile jaw crusher assembly is attached.

### DETAILED DESCRIPTION

Reference will now be made in detail to embodiments of the invention, one or more examples are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

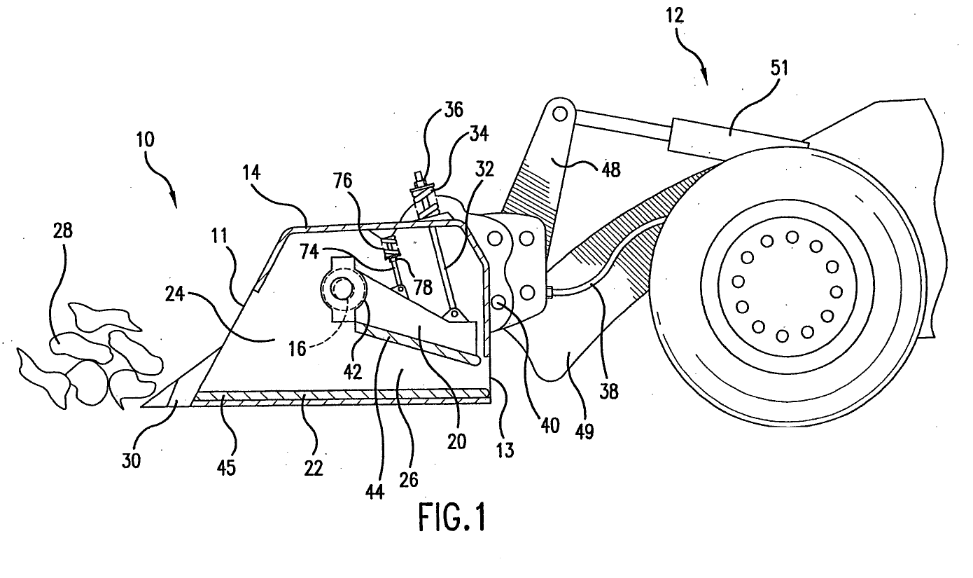

FIG. 1 shows an exemplary embodiment of a mobile jaw crusher assembly 10 in accordance with the present invention. The mobile jaw crusher assembly 10 is configured with a connection member 40 that allows for the attachment of the assembly 10 to a vehicle 12. The connection member 40 may be for instance a bolted connection, or may be a welded or interlocking connection. The vehicle 12 shown in FIG. 1 is a front end loader. However, it is to be understood that the mobile jaw crusher assembly 10 may be configured to be attachable to various types of vehicles 12, which may be self-propelled. For instance, the mobile jaw crusher assembly 10 may be configured to be attached to a hydraulic excavator, a shovel, and/or a crane. As such, the mobile jaw crusher assembly 10 of the present invention is not limited to attachment, or configuration to be attached, to a particular type of vehicle 12.

The connection member 40 may be a quick disconnect member such that the mobile jaw crusher assembly 10 can be easily and quickly connected to and from the vehicle 12. Alternatively, the connection member 40 may also be a permanent type connection wherein the mobile jaw crusher assembly 10 is permanently affixed to the vehicle 12. As such, the mobile jaw crusher assembly 10 is not limited to a particular type of connection member 40.

The mobile jaw crusher assembly 10 may be used in a variety of applications. For instance it may be used in the construction, demolition, recycling, aggregate, and or excavation industries. The mobile jaw crusher assembly 10 may be provided as a retrofit unit to replace the bucket that typically is present on the front of a front-end loader. Alternatively, the mobile jaw crusher assembly 10 may be sold as an integrated unit with the vehicle 12.

The configuration of the mobile jaw crusher assembly 10 includes a first crushing member 20 that faces a second crushing member 22, a crushing chamber 26 being defined therebetween. It is known in the art to configure jaw crushers such that a “V” shaped arrangement is defined by a side view of a pair of crushing members. For instance please see U.S. Pat. No. 5,749,530 by Nakayama and U.S. Pat. No. 4,361,289 by Georget for examples of different ways of configuring a jaw crusher, these two patents being incorporated by reference into the present application in their entirety for all purposes.

As shown in FIG. 1, where the end of a frame 14 has been cut away to reveal its internally disposed components, the first crushing member 20 and the second crushing member 22 are arranged such that one may be moved relative to the other. Here the second crushing member 22 is attached and fixed relative to the frame 14. The first crushing member 20 is movable with respect to the frame 14 and the second crushing member 22. An eccentric shaft 16 is present and is rotatably mounted to the frame and may be rotated with respect to the frame 14.

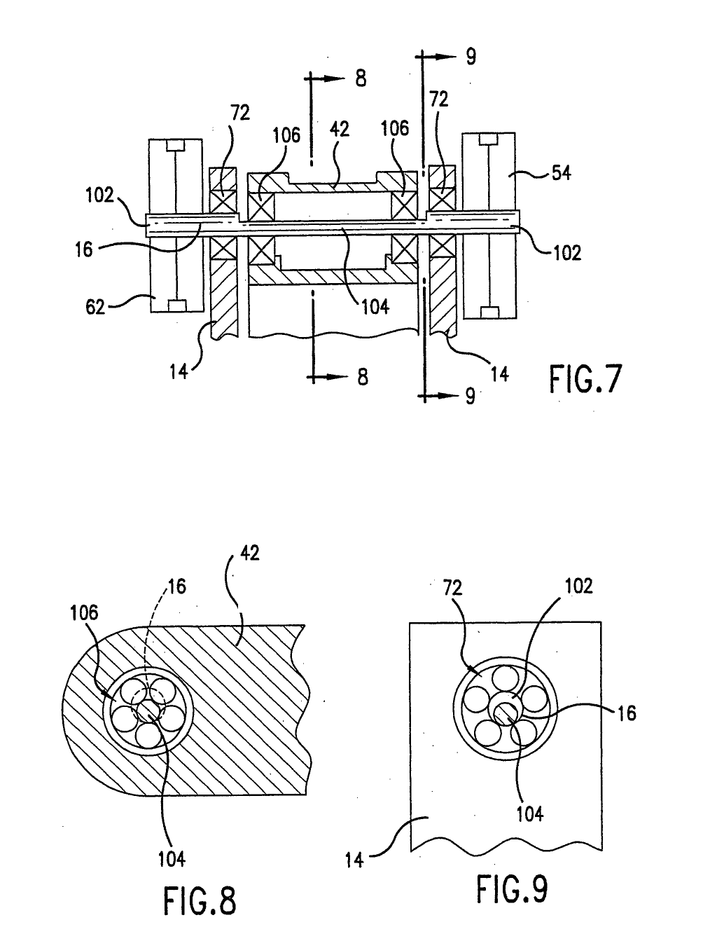

In one exemplary embodiment of the present invention, the eccentric shaft 16 as shown in FIG. 7 is comprised of two outer cylinders 102 that are concentric with respect to one another about a central axis of rotation. Shaft 16 also includes a middle cylinder 104 that has a rotational axis that is offset from the central rotational axis of the two outer cylinders 102. Rotation of the shaft 16 about the central rotational axis of outer cylinders 102 therefore provides for an eccentric motion of middle cylinder 104 of the eccentric shaft 16. The two outer cylinders 102 are each engaged by and rotate within a bearing 72. The middle cylinder 104 is housed within and is rotatable in a pair of shaft housing bearings 106. The middle cylinder 104 of the eccentric shaft 16 engages a shaft housing 42 through the shaft housing bearings 106. As such, the eccentric shaft 16 is in communication with the shaft housing 42. FIG. 8 is a view taken along line 8-8 of FIG. 7, and schematically shows the shaft housing 42 engaging the eccentric shaft 16 on the middle cylinder 104 through the shaft housing bearings 106. Additionally, FIG. 9 is taken along line 9-9 of FIG. 7, and schematically shows the relative positions of the middle cylinder 104 and the outer cylinder 102 of the eccentric shaft 16. Referring now back to FIG. 1, the shaft housing 42 rigidly engages the first crushing member 20. Rotation of the eccentric shaft 16 therefore causes a corresponding movement in shaft housing 42 and the first crushing member 20. Due to the eccentric engagement, rotation of the eccentric shaft 16 causes the first crushing member 20 to be moved closer to and then away from the second crushing member 22 upon rotation of the eccentric shaft 16. The shaft housing 42 engages the first crushing member 20 and is pivotally mounted on the eccentric shaft 16. The upper portion of the first crushing member 20 is therefore supported by the eccentric shaft 16.

As shown in FIG. 1 for example, the lower portion of the first crushing member 20 is supported by a first rod 32 that is pivotally connected to the first crushing member 20. The first rod 32 passes slideably linearly through the frame 14 and has a nut 36 threadingly engaged on the end that is disposed outside frame 14. A spring 34 is present and is located between the nut 36 and the exterior of the frame 14. The spring 34 provides a tension in the first rod 32 such that the first rod 32 tends to lift the lower end of the first crushing member 20 toward nut 36 as shown in FIG. 1.

A second rod 74 may also be present in the mobile jaw crusher assembly 10. The second rod 74 is pivotally attached to the first crushing member 20 at a point between the first rod 32 and where the first crushing member 20 engages shaft housing 42. A second spring 76 is present and is placed between the interior of the frame 14 and a second nut 78 that threadingly engages the second rod 74. This arrangement causes the spring 76 to press against the nut 78 such that a downward force away from frame 14 as shown in FIG. 1 is imparted onto the second rod 74 and causes a correspondingly downward force onto the first crushing member 20 as shown in FIG. 1.

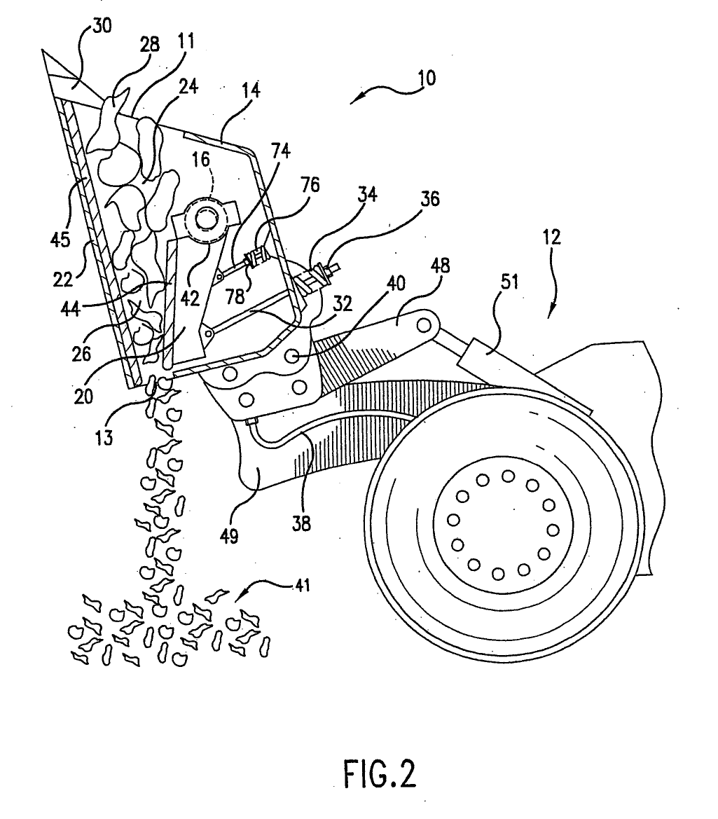

The arrangement of the first rod 32 and the second rod 74 helps to maintain the proper positioning of the first crushing member 20 when the mobile jaw crusher assembly 10 is rotated between a horizontal scooping position (FIG. 1) and a vertical crushing position as can be seen schematically in FIG. 2. The arrangement also helps to provide for a desirable positioning of the first crushing member 20 during operational procedures of the mobile jaw crusher assembly 10. Additionally, the tension, imparted through the first rod 32 and the second rod 74, may help to increase the performance of the mobile jaw crusher assembly 10 during crushing procedures.

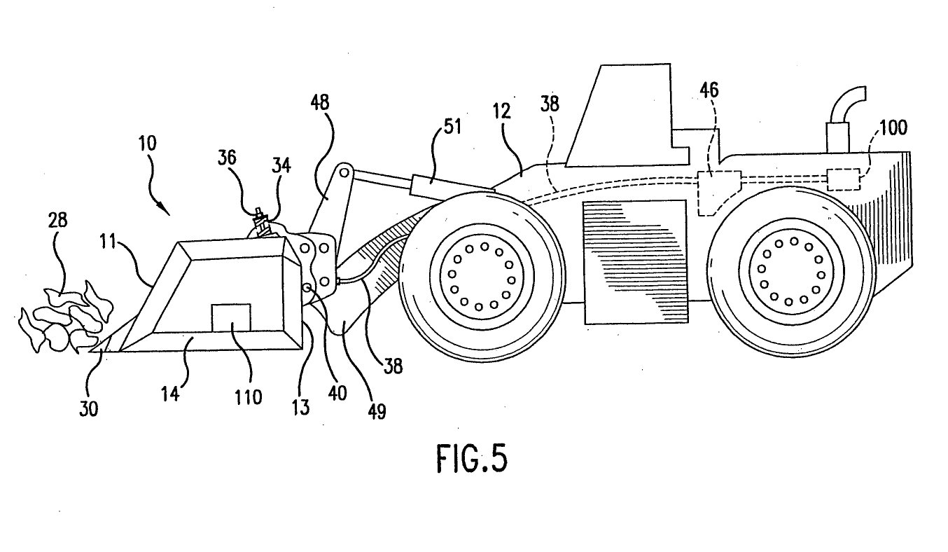

Referring back to FIG. 1, the rotation of the eccentric shaft 16 may be obtained through an electrical or hydraulic motor as will be later discussed. If a hydraulic motor is present, the hydraulic motor may be powered by a hydraulic source 100 of a diesel system 46 as shown in FIG. 5, and connected via a pressure line 38 containing hydraulic fluid. It is therefore the case that the exemplary embodiment shown in FIG. 1 includes a mobile jaw crusher assembly 10 that is powered by the hydraulic source 100 of the vehicle 12. However, it is to be understood that in other exemplary embodiments of the present invention the mobile jaw crusher assembly 10 may be powered by an independent hydraulic source that is separate from the vehicle 12.

As shown in FIG. 1, the vehicle 12 may move forward such that objects 28 are urged through an inlet opening 11 of the frame 14 into a holding chamber 24 of the mobile jaw crusher assembly 10. Teeth 30 may be present on the frame 14 near the inlet opening 11 in order to assist in digging objects 28 or placing objects 28 into the holding chamber 24. As such, the vehicle 12 may manipulate the mobile jaw crusher assembly 10 so that the objects 28 are both torn from a pile and/or loaded into the holding chamber 24 of the mobile jaw crusher assembly 10. The vehicle 12, in this case a front end loader, is equipped with a vehicle pivoting arm 48. The connection member 40 of the mobile jaw crusher assembly 10 engages the vehicle pivoting arm 48. A hydraulic cylinder 51 is present on the vehicle 12 and may be actuated in order to at least partially rotate the vehicle pivoting arm 48. Rotating the vehicle arm 48 results in a corresponding rotating movement of the mobile jaw crusher assembly 10. Vehicle 12 also is provided with a lifting arm 49, which can be raised and lowered in a vertical direction from the lowered position shown in FIG. 1 to the raised position shown in FIG. 2 for example.

FIG. 2 shows the exemplary embodiment of the mobile jaw crusher assembly 10 of FIG. 1 during crushing procedures. Here, the hydraulic cylinder 50 as been actuated such that the vehicle connection arm 48 is rotated causing the mobile jaw crushing assembly 10 to be tilted in a substantially vertical direction. Lifting arm 49 has also been moved to a relatively elevated position that lifts assembly 10 above the ground. Objects 28 are present within the holding chamber 24 of the mobile jaw crusher assembly 10. The holding chamber 24 may or may not be full of the crushed objects 41 upon being rotated and lifted. The eccentric shaft 16 is rotated, and this rotation results in a corresponding movement of the first crushing member 20 relative to the second crushing member 22. As can be seen in FIG. 2, the presence of the second rod 74 along with the spring 76 and nut 78 helps to ensure that the first crushing member 20 does not rotate out of a desired operating position during tilting and rotation of the mobile jaw crusher assembly 10.

The crushing surface of the first crushing member 20 has a side 21 that is provided with a first manganese liner 44. The crushing surface of the second crushing member 22 has a side 23 that is provided with a second manganese liner 45. Relative movement of the first crushing member 20 with respect to the second crushing member 22 causes the objects 28 to be crushed between the first and second manganese liners 44 and 45. As the objects 28 are crushed, they fall downward into a narrower portion of the crushing chamber 26 where they are again crushed by the first and second manganese liners 44 and 45 into an even smaller size. This continues until the objects 28 fall from the crushing chamber 26 through an outlet opening 13 of the frame 14 and into a pile of crushed objects 41. The size of the crushed objects 41 may be regulated by adjusting the relative distance between the first and second crushing members 20 and 22. In one exemplary embodiment of the present invention, the crushed objects 41 are approximately 1 and ½ inches in size, which is the largest dimension from any one exterior point to any other exterior point. However, the invention is not limited to producing crushed objects 41 of 1 and ½ inches in size, but may produce crushed objects 41 of various sizes in other exemplary embodiments of the present invention.

Base material specifications may vary among different states and/or job specifications. Adjustment of the size of the crushing chamber 26 may be important due to the fact that variously sized crushed objects 41 are needed in various situations. The adjustment of the distance between the first and second crushing members 20 and 22 and hence the size of the crushing chamber 26 may be adjusted by tightening or loosening the nuts 78 and 36. Such an adjustment would cause a corresponding change in the amount of tension imparted through the rods 32 and 74. This in turn would cause a change in the displacement of the lower end of the first crushing member 20 and hence act to modify the distance between the first and second crushing members 20 and 22.

By modifying the size of the crushing chamber 26, varying sizes of crushed objects 41 may be realized. Additionally, through normal use and wear of the mobile jaw crusher assembly 10, the first and second manganese liners 44 and 46 may be worn through continued operation. It may therefore be desirable to adjust the size of the crushing chamber 26 in order to compensate for this normal wear of the first and second manganese liners 44 and 45.

A saleable product is one that does not need to be transported by separate machinery to or from the jaw crusher, or a product that is further processed by separate machinery. Previous mobile jaw crusher assemblies 10 were typically fed objects 28 by a conveyor system that had a screening system attached thereto wherein the objects 28 were screened and then conveyed into the jaw crusher. These screened objects were then crushed by the jaw crusher and were further conveyed from the jaw crusher. The present invention is not limited to producing only saleable products. In other exemplary embodiments, saleable and/or nonsaleable products may be produced.

As shown in FIG. 2, objects 28 may be placed into the mobile jaw crusher assembly 10. The objects 28 are then reduced into the crushed objects 41 which may represent a saleable product. As such, the step of feeding and/or screening the objects 28 before entry into the mobile jaw crusher assembly 10 has been eliminated. The mobile jaw crusher assembly 10 therefore allows for multiple piles of crushed objects 41 to be stock-piled without the use of conveyors. Additionally, the mobile jaw crusher assembly 10 may allow for crushed objects 41 to be placed into screeners for further processing without the use of conveyors.

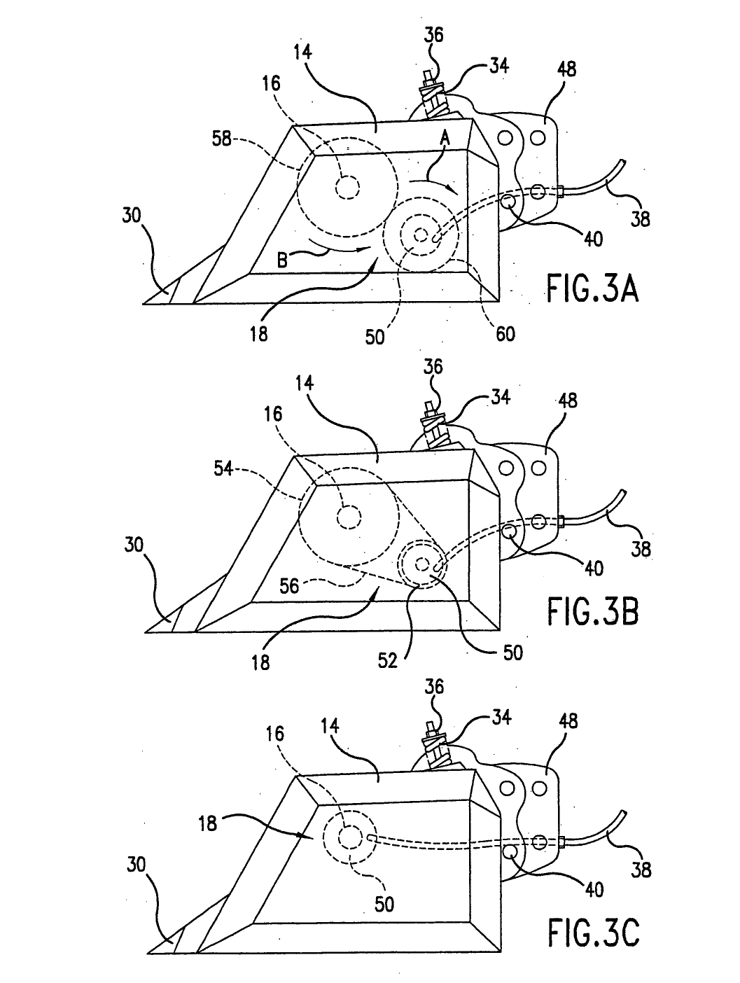

FIG. 3A shows an exemplary embodiment of a driving mechanism 18 that is used to rotate the eccentric shaft 16 in accordance with the present invention. Here, a hydraulic motor 50 is present and is attached to the frame 14. The hydraulic motor 50 is powered by the hydraulic source 100 of the vehicle 12 through the hydraulic line 38. The hydraulic line 38 is run through the connection member 40 and into the frame 14, finally connecting with the hydraulic motor 50. The eccentric shaft 16 is in communication with a first frictionally engaging member 58. In one exemplary embodiment of the present invention, the first frictionally engaging member 58 is a first rubber tire 58. A second frictionally engaging member 60 is in communication with the hydraulic motor 50 such that rotation of the hydraulic motor 50 causes a corresponding rotation of the second frictionally engaging member 60. In one exemplary embodiment of the present invention, the second frictionally engaging member 60 is a second rubber tire 60. The rotation of the second rubber tire 60 is shown in the direction of arrow A in FIG. 3A. The first and second rubber tires 58 and 60 may be inflated such that they will press against one another. Rotation of the second rubber tire 60 in the direction of arrow A causes a corresponding rotation of the first rubber tire 50 in the direction of arrow B due to this engagement. Since the first rubber tire 58 is in communication with the eccentric shaft 16, rotation of the first rubber tire 58 causes a corresponding rotation of the eccentric shaft 16.

By changing the diameter of the first rubber tire 58 and/or the second rubber tire 60, the speed of the eccentric shaft 16 may be varied which can ultimately cause a varying size of the crushed objects 41. Additional output sizes of the crushed objects 41 may be obtained by varying the hydraulic pressure supplied to the hydraulic motor 50 or by varying the speed of the electric motor if an electric motor is used in other exemplary embodiments.

FIG. 3B shows an alternative exemplary embodiment of the driving mechanism that may be used in the mobile jaw crusher assembly 10. Here, the hydraulic source 100 of the vehicle 12 is again run into the frame 14 via the hydraulic lines 38 and powers a hydraulic motor 50. The hydraulic motor 50 is coupled to a drive pulley 52. A driven pulley 54 is present and is in communication with the eccentric shaft 16. A belt 56 is provided and engages both the drive pulley 52 and the driven pulley 54. Rotation of the hydraulic motor 50 causes a corresponding rotation of the drive pulley 52 and movement of the belt 56. Movement of the belt 56 around the driven pulley 54 causes the driven pulley to rotate and hence results in a corresponding rotation of the eccentric shaft 16 due to the coupling of the driven pulley 54 to the eccentric shaft 16. The belt 56 may be a V-belt in certain exemplary embodiments of the present invention, however other belts as known in the art may be employed. Additionally, the drive pulley 52 and/or the driven pulley 54 may have variously grooved surfaces in order to assist in the retention of the belt 56 thereon and provide for an adequate amount of rotational transfer between the drive pulley 52 and the driven pulley 54. In another exemplary embodiment of the present invention, a sprocket wheel and chain drive arrangement may be used in place of the drive pulley 52, driven pulley 54, and belt 56 arrangement.

Another exemplary alternative embodiment of the driving mechanism 18 is shown in FIG. 3C. Here, the hydraulic motor 50 is directly mounted onto the eccentric shaft 16. The hydraulic source of the vehicle 12 is fed into the hydraulic motor 50 and causes rotation of the hydraulic motor 50. Rotation of the hydraulic motor 50 imparts a corresponding rotation of the eccentric shaft 16. A cylindrical section of the eccentric shaft 16 may be bored out to allow the shaft of the hydraulic motor 50 to fit therein. Additionally, a coupling may be present between the hydraulic motor 50 and the eccentric shaft 16 in order to provide for the communication of rotation between these two members. A hydraulic control valve (not shown) may be provided in order to regulate the rotational speed of the hydraulic motor 50 and hence control the rotation of the eccentric shaft 16.

Although each of the driving mechanisms 18 shown in FIGS. 3A, 3B, and 3C employs a hydraulic motor 50, it is to be understood that an electrical motor may be substituted therefor to provide for the aforementioned rotation of the eccentric shaft 16. Additionally, the power source for either the electric motor or the hydraulic motor 50 does not need to be provided by the vehicle 12 in other exemplary embodiments of the present invention. For instance, as schematically shown in FIG. 5, in one exemplary embodiment of the present invention, a separate diesel/hydraulic power source 110 may be provided on the frame 14 in order to run the hydraulic motor 50. Such an independent diesel/hydraulic source (e.g. 110 in FIG. 5) is separate from a diesel and hydraulic system 46 of the vehicle 12 that supplies hydraulic fluid through the hydraulic line 38 from the hydraulic source 100 as shown in FIG. 5. Alternatively, a separate source of power may be provided on the frame 14 and may be used to power an electric motor that is used in place of the hydraulic motor 50. Referring back to FIG. 1, additional ways of driving the eccentric shaft 16 are possible, as is known in the art, and the present invention is not limited to a particular mode of driving the eccentric shaft 16.

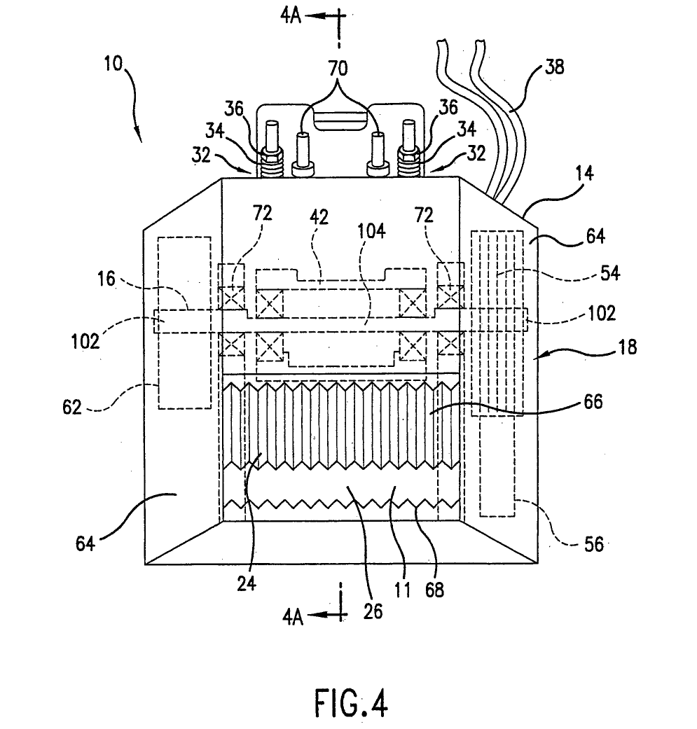

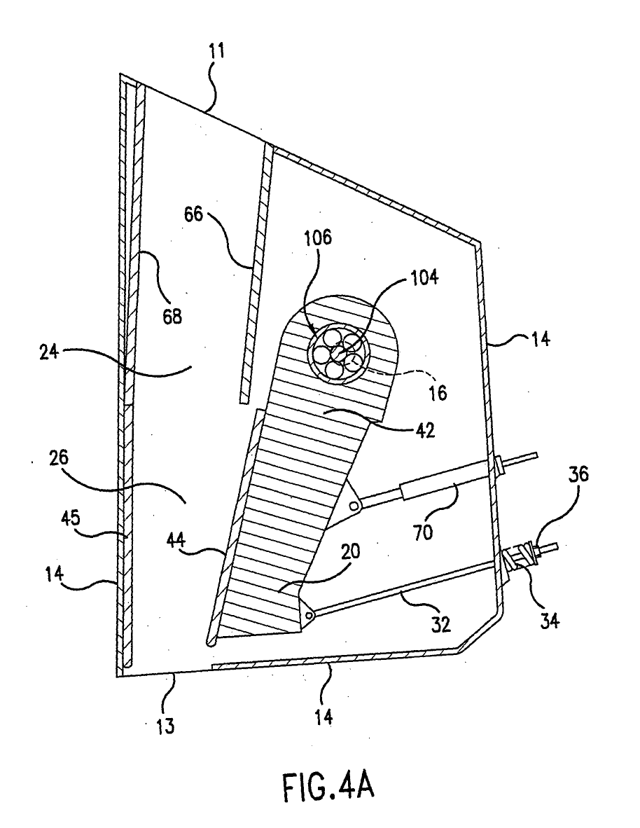

FIG. 4 shows a front view of another exemplary embodiment of the mobile jaw crusher assembly 10 in accordance with the present invention. Here, the shaft housing 42 is shown as being located in approximately the center of the frame 14. A pair of bearings 72 support the eccentric shaft 16 on either end. The shaft housing bearings (106 in FIG. 7) are positioned within the shaft housing 42 and help ensure a relatively smooth rotation of the eccentric shaft 16 within the shaft housing 42. FIG. 7 and the related discussion provide a more detailed description of how the shaft housing 42 is in communication with the eccentric shaft 16. The driving mechanism 18 is the pulley system displayed in FIG. 3B. Here, the driven pulley 54 is moved by the belt 56 to transfer its motion onto the eccentric shaft 16. A counter weight 62 is placed on an opposite end of the eccentric shaft 16 from the driving mechanism 18 in order to counter the weight of the driven pulley 54 on the eccentric shaft 16.

As shown in FIGS. 4 and 4A for example, a dividing member 66 shown as an angled guard 66 is shown as being located within the holding chamber 24 of the frame 14. As shown in FIG. 4A, the angled guard 66 extends down to and is proximate to the crushing chamber 26. The angled guard 66 is angled such that the upper portion of the angled guard 66 is near the outside of the frame 14 while the lower portion of the angled guard 66 is proximate to the crushing chamber 26. The angled guard 66 helps maintain the objects 28 within the holding chamber 24 of the mobile jaw crusher assembly 10, and also helps to channel the objects 28 into the crushing chamber 26. A second angle guard 68 is also present in the exemplary embodiment shown in FIGS. 4 and 4A. The second angled guard 68 is configured to help hold the objects 28 within the holding chamber 24 of the mobile jaw crusher assembly 10. The second angled guard 68 is sloped downwardly in FIGS. 4 and 4A such that the lower portion of the second angle guard 68 is proximate to the crushing chamber 26. The second angled guard 68 also helps to ensure that the objects 28 are properly channeled into the crushing chamber 26 in order to be crushed by the mobile jaw crusher assembly 10.

The frame 14 is equipped with steel guards 64 on either end to help protect the counter weight 62, the driving mechanism 18, and the bearings 72. It is often the case that the mobile jaw crusher assembly 10 will be slammed into the objects 28 and hence be subjected to a high degree of force thereon. The steel guards 64 act to protect various elements of the mobile jaw crusher assembly 10 and also help to provide for a stronger structural integrity of the frame 14.

The exemplary embodiment of the mobile jaw crusher assembly 10 shown in FIG. 4 is shown having two first rods 32 being present, each having a spring 34 and a nut 36 thereon in order to help properly position the first crushing member 20 (not shown in FIG. 4). However, unlike the exemplary embodiment shown in FIG. 1, a second rod 74 is not shown in FIG. 4. One of the purposes of the second rod 74 in FIG. 1 was to help properly position the first crushing member 20 during rotation of the mobile jaw crusher assembly 10. In the exemplary embodiment shown in FIG. 4, a hydraulic cylinder 70 has been substituted for the second rod 74. This can be seen more clearly in FIG. 4A. The hydraulic cylinder 70 may be actuated such that the proper positioning of the first crushing member 20 (not shown in FIG. 4) is maintained. Additionally, each hydraulic cylinder 70 may be configured such that it acts as a dampening member when force due to the weight of the first crushing member 20 acts thereon. This can be accomplished by incorporating an internal valve into the hydraulic cylinder 70 circuit to provide a varying or constant resistive pressure. In essence, the hydraulic cylinder 70 can be configured to perform essentially the same functions as the second rod 74 in FIG. 1. While two hydraulic cylinders 70 are shown in FIG. 4, it is to be understood that any number of hydraulic cylinders 70 and/or the first rods 32 may be employed in other exemplary embodiments of the present invention. Additionally, the presence of the rods 32 and 74 along with the hydraulic cylinders 70 may not be necessary in other exemplary embodiments of the present invention.

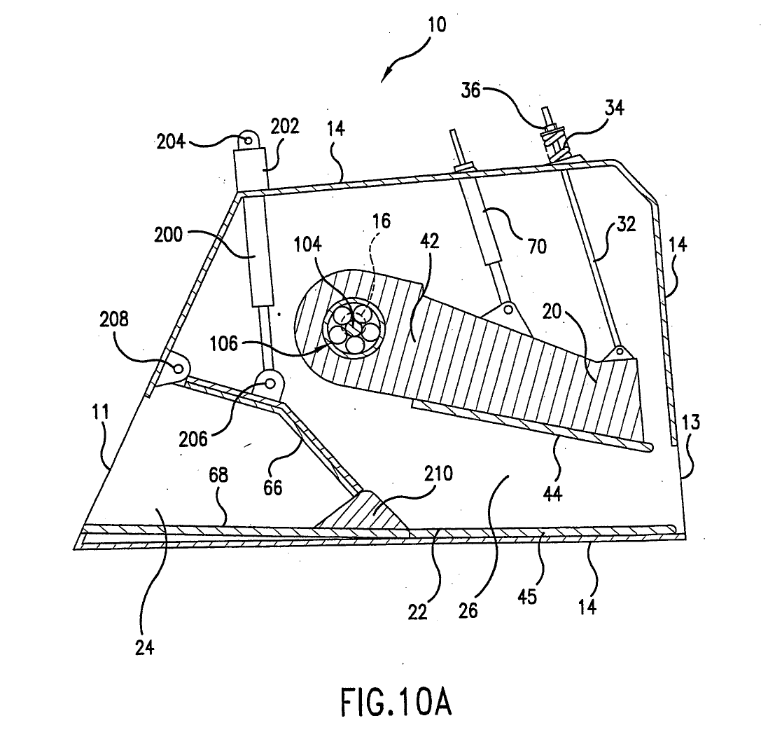

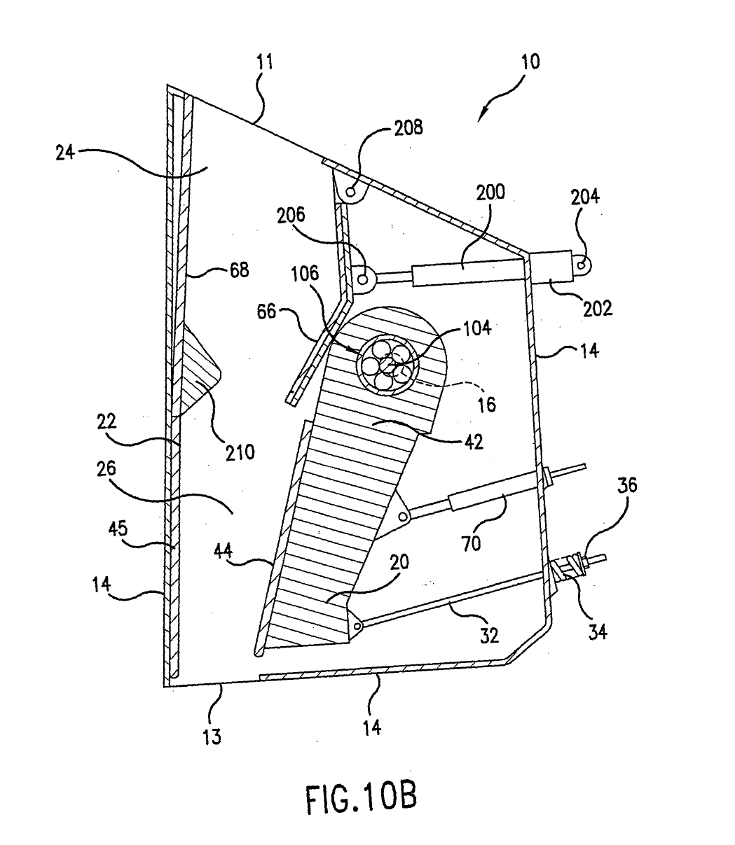

Another exemplary embodiment of the present invention is shown in FIGS. 10A and 10B. Here, the mobile jaw crusher assembly 10 is provided with a hydraulic cylinder 200 that is pivotally attached to the angled guard 66 at a pivot connection 206. The hydraulic cylinder 200 extends through the frame 14 and is housed on one end by a cover 202. The hydraulic cylinder 200 is pivotally connected to the cover 202 at a pivot connection 204. The angled guard 66 is pivoted on one end by a hinge 208, which is connected to the frame 14. A deflector 210 is present in this exemplary embodiment and is connected to the second angled guard 68. In one exemplary embodiment of the present invention, the deflector 210 may be a solid steel deflector 210 having generally triangular cross sections and extending width wise along the full width of the second angled guard 68.

As shown in FIG. 10, the hydraulic cylinder 200 may be actuated such that the angled guard 66 is rotated about the hinge 208 and contacts the deflector 210. Once this occurs, the holding chamber 24 of the mobile jaw crusher assembly 10 is isolated from the crushing chamber 26. The mobile jaw crusher assembly 10 may be manipulated by the vehicle 12 such that the holding chamber 24 acts a conventional bucket and objects 28 (not shown in FIG. 10A) may be placed within the holding chamber 24 as would be the case with a conventional bucket.

Before allowing the material in the holding chamber 24 to enter the crushing chamber 26, the eccentric shaft 16 may then be rotated such that the first crushing member 20 is moving back and forth relative to the second crushing member 22. At this point, the mobile jaw crusher assembly 10 may be rotated into the position shown in FIG. 10B. The hydraulic cylinder 200 may then be actuated in order to move the angled guard 66 away from the deflector 210. Doing so will cause the objects 28 (not shown in FIG. 10B) to fall at a controlled rate from the holding chamber 24 into the crushing chamber 26. The objects 28 will be crushed by relative movement between the first and second crushing members 20 and 22 as described above in regards to previous embodiments of the present invention.

The incorporation of the angled guard 66 along with the hydraulic cylinder 200 allows for a controlled feeding of the objects 28 into the crushing chamber 26. Additionally, the relative motion between the first and second crushing members 20 and 22 may begin before the objects 28 are placed therebetween. As such, relative motion may begin before tilting or after tilting the mobile jaw crusher assembly 10 as shown in FIG. 10B. This type of crushing arrangement may be more beneficial in some respects as compared to those in which the relative motion between the crushing members 20 and 22 begins while objects 28 are therebetween. Additionally, the provision of the angled guard 66 in conjunction with the hydraulic cylinder 200 also allows for the benefit for placing objects 28 within the holding chamber 24 without unwanted falling of the objects 28 through the outlet opening 13 in the frame 14. This is due to the fact that the angled guard 66 is positioned such that the holding chamber 24 is isolated from the outlet opening 13. Further, the mobile jaw crusher assembly 10 may be in motion while digging. In other exemplary embodiments, more than one hydraulic cylinder 200 may be used. For instance, two hydraulic cylinders 200 may be employed in other exemplary embodiments of the present invention.

FIG. 5 shows an exemplary embodiment of the mobile jaw crusher assembly 10 attached to the vehicle 12 that is a front end loader. The vehicle 12 is provided with an independent diesel system 46 which helps power the hydraulic source 100 of the vehicle 12. As stated, this hydraulic source 100 may be used to run the mobile jaw crusher assembly 10. Here, the mobile jaw crusher assembly 10 is positioned by the vehicle 12 such that it is prepared to scoop objects 28 into the interior of the frame of the mobile jaw crusher assembly 10 through the inlet opening 11. Since the mobile jaw crusher assembly 10 is replacing the standard bucket of the vehicle 12, the operator of the vehicle 12 may use the mobile jaw crusher assembly 10 to scoop the objects 28 to be crushed in much the same way as the operator would use the normal bucket when using the vehicle. Additionally, a separate diesel/hydraulic source 110 may be carried by the frame 14. Such a diesel/hydraulic source 110 may be used to power the mobile jaw crusher assembly 10 independent from the hydraulic source 100 of the vehicle 12.

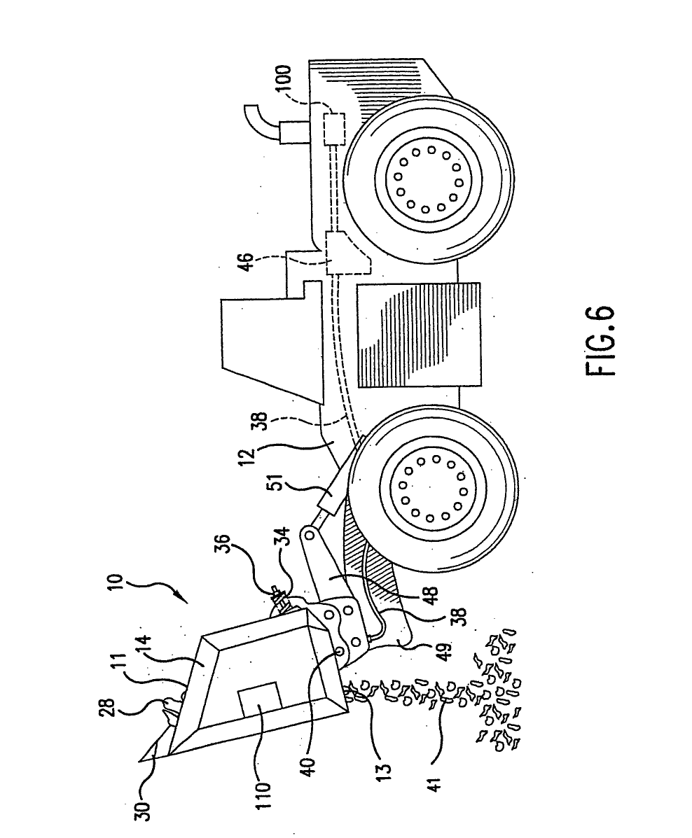

FIG. 6 shows the exemplary embodiment of the mobile jaw crusher assembly 10 of FIG. 5 once the objects 28 have been placed within the frame 14 and the hydraulic cylinder 51 of the vehicle 12 has been actuated in order to lift and rotate the mobile jaw crusher assembly 10. At this point the mobile jaw crusher assembly 10 begins crushing the objects 28 such that crushed objects 41 are deposited out of the outlet opening 13 of the frame 14 into a stock pile. Aside from depositing the crushed objects 41 into a stock pile, the crushed objects 41 may be deposited into another vehicle such as a dump truck, or may be deposited onto a conveyor system to be transported away from the site. Additionally, the crushed objects 41 may be deposited into a second jaw crusher or another type of crusher for further processing of the crushed objects 41. However, in other exemplary embodiments of the present invention, the crushed objects 41 which exit the mobile jaw crusher assembly 10 are of a desired size such that they are a saleable product and further processing of the crushed objects 41 is not necessary.

Although shown as being attached to a front end loader, the vehicle 12 onto which the mobile jaw crusher assembly 10 may be attached may be any type of vehicle that is capable of rotating the mobile jaw crusher assembly 10. For instance, an articulated vehicle 12 that is capable of lifting and rotating the mobile jaw crusher assembly 10 may be used. Additionally, the power source of this vehicle 12 can be used to run the mobile jaw crusher assembly 10 such that an independent power source is not needed on the mobile jaw crusher assembly 10. The vehicle 12 may therefore allow for the objects 28 to be lifted, crushed, and deposited while the vehicle 12 is either stationary or moving, walking, or creeping in nearly any direction.

Previous jaw crushers required objects to be fed to the jaw crusher for processing. As such, a machine was required to obtain the objects and/or transport the objects. Further, a separate machine was needed in order to transport the objects from the jaw crusher. By having a mobile jaw crusher assembly 10, the vehicle 12 may perform all of these tasks. For instance, objects 28 may be placed within the mobile jaw crusher assembly 10 by the vehicle 12, the vehicle 12 may move to a suitable depositing site, and the objects 28 may be crushed by the mobile jaw crusher assembly 10 either during transport, or once the vehicle 12 has been moved to the desired depositing site. Also by crushing the objects 28 during movement of the vehicle 12, the crusher assembly permits the crushed objects to be spread over any desired area and transforms the vehicle into a spreader. As such, the mobile jaw crusher assembly 10 eliminates various stages commonly used in known crushing and distribution procedures.

The mobile jaw crusher assembly 10 may be produced as a separate unit that is configured for attachment to the vehicle 12, or the mobile jaw crusher assembly 10 may be provided as an integrated unit with the vehicle 12.

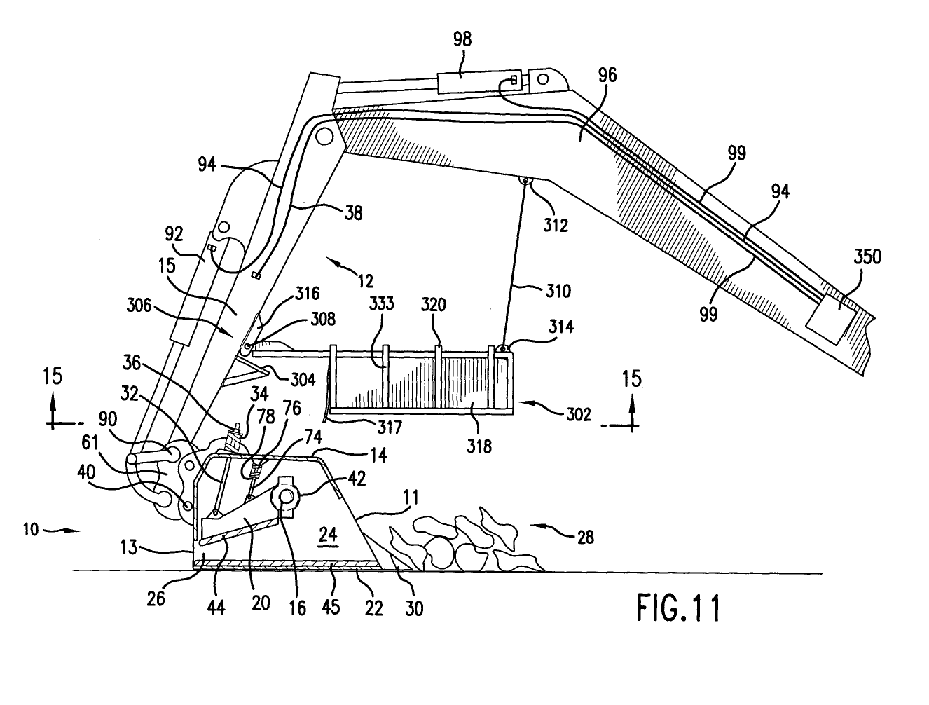

Referring now to FIG. 11, another exemplary embodiment of the mobile jaw crusher assembly 10 is shown attached to an arm 15 of a vehicle 12 that is an excavator. A pivot 90 is provided on a portion of the arm 15 near one end thereof. A linkage member 61 is pivotally connected to pivot 90 and connected to crusher assembly 10. A hydraulic cylinder 92 is also provided on the arm 15. One end of the hydraulic cylinder 92 is pivotally attached to the arm 15. An opposite end of the hydraulic cylinder 92 is pivotally attached to linkage member 61. Actuation of the hydraulic cylinder 92 results in a corresponding rotation of the mobile jaw crusher assembly 10 about the pivot 90. Such a pivoting arrangement is commonly known in the art. A hydraulic cylinder line 94 feeds hydraulic fluid to the hydraulic cylinder 92. Although the exemplary embodiment shown in FIG. 11 makes use of hydraulics in order to move and rotate the mobile jaw crusher assembly 10, it is to be understood that other mechanisms are possible in accordance with the present invention. For instance, a gear train arrangement could be used in order to provide the required movement and/or rotation of the mobile jaw crusher assembly 10.

FIG. 11 also shows the excavator 12 as including a second excavator arm 96 that is attached to the arm 15. The second excavator arm 96 also has a second hydraulic cylinder 98 being attached thereto and being powered by the diesel/hydraulic system 350 of the excavator 12. Actuation of the second hydraulic cylinder 98 causes a corresponding rotation of the arm 15 about the second excavator arm 96. As can be seen from this arrangement, it is possible for the excavator 12 to manipulate the mobile jaw crusher assembly 10 such that objects 28 are able to be scooped into the frame 14 of the mobile jaw crusher assembly 10. Hydraulic fluid may be supplied to one or more of the aforementioned components through hydraulic lines 99 which are in hydraulic communication with the diesel/hydraulic system 350.

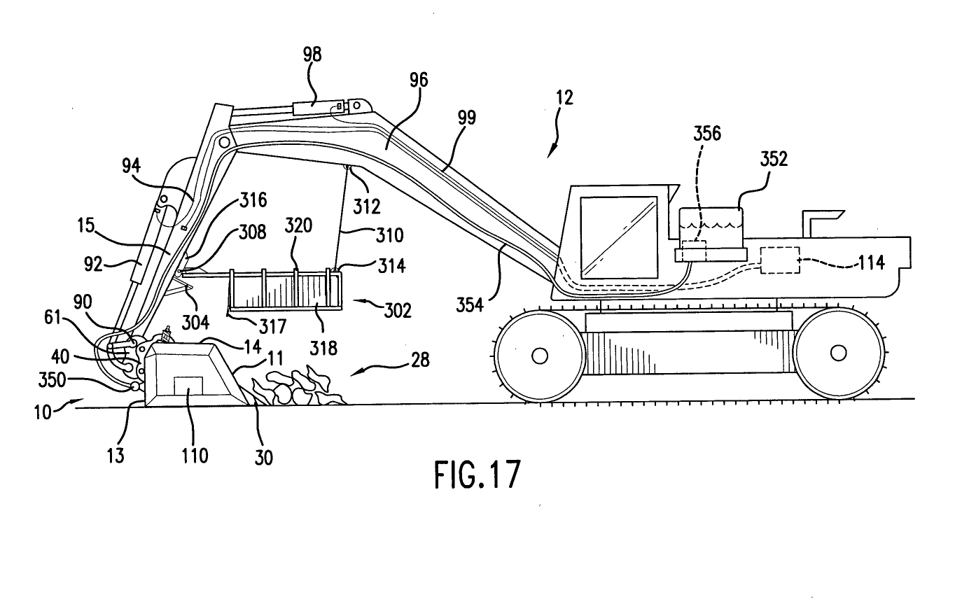

A guard 302 is provided and is attached to the arm 15 of the excavator 12 (FIG. 17). The guard 302 is positioned away from the inlet opening 11 of the frame 14 such that objects 28 may be scooped into the mobile jaw crusher assembly 10 through the inlet opening 11. In this regard, the guard 302 is pivotally attached to the arm 15 by a hinge 306. The guard 302 is further held in the position shown in FIG. 11 by a cable 310. As can be seen in FIG. 11, when the excavator 12 is not crushing the objects 28, the guard 302 may be held away from the frame 14 by the hinge 306 and the cable 310.

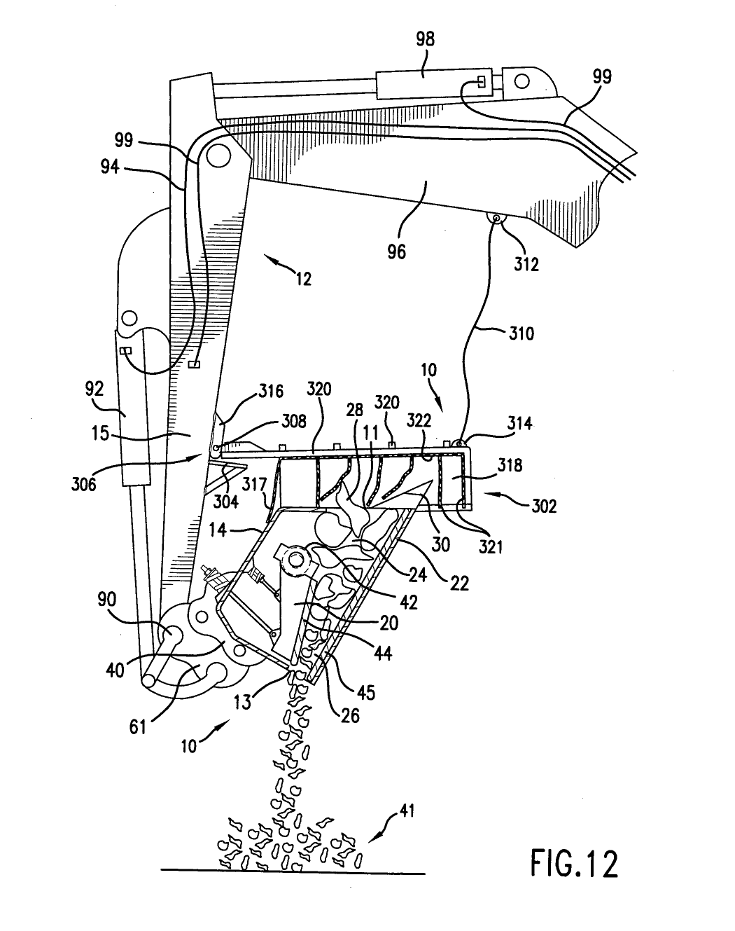

Referring now to FIG. 12, the mobile jaw crusher assembly 10 of FIG. 11 is shown in the crushing position. Here, the frame 14 is rotated into the crushing position such that the guard 302 blocks the inlet opening 11 (FIG. 11) of the frame 14. The guard 302 prevents the objects 28 from exiting the mobile jaw crusher assembly 10 through the inlet opening 11 (FIG. 11). Absent the positioning of guard 302 as shown in FIG. 12, objects 28 may be inadvertently thrown out of the mobile jaw crusher assembly 10 through the inlet opening 11 (FIG. 11) due to the crushing procedure brought about by relative movement between the first and second crushing members 20, 22 causing objects 28 to be moved throughout the interior of the frame 14. The guard 302 may also assist in the dampening of noise associated with the crushing of objects 28 by the mobile jaw crusher assembly 10. The guard 302 may therefore deflect objects 28 that are thrown upward while the mobile jaw crusher assembly 10 is operating. Consequently, the guard 302 may protect the excavator 12 from being damaged. The guard 302 may be configured in order to block the entire inlet opening 11, or may be configured in order to block only a portion of the inlet opening 11 in accordance with various exemplary embodiments. A portion of the side face of the guard 302 is cut away in FIG. 12 in order to show the objects 28 being blocked by the guard 302.

As can be seen in FIG. 12, the frame 14 engages the guard 302 such that the guard 302 is slightly lifted off of a support member 304. The support member 304 may be a welded structure attached to the arm 15 of the excavator 12. The support member 304 may be used to support the guard 302 when the guard 302 is not engaged by the frame 14. Further, the support member 304 may be used as a stop in order to prevent the guard 302 from rotating or moving past a desired location.

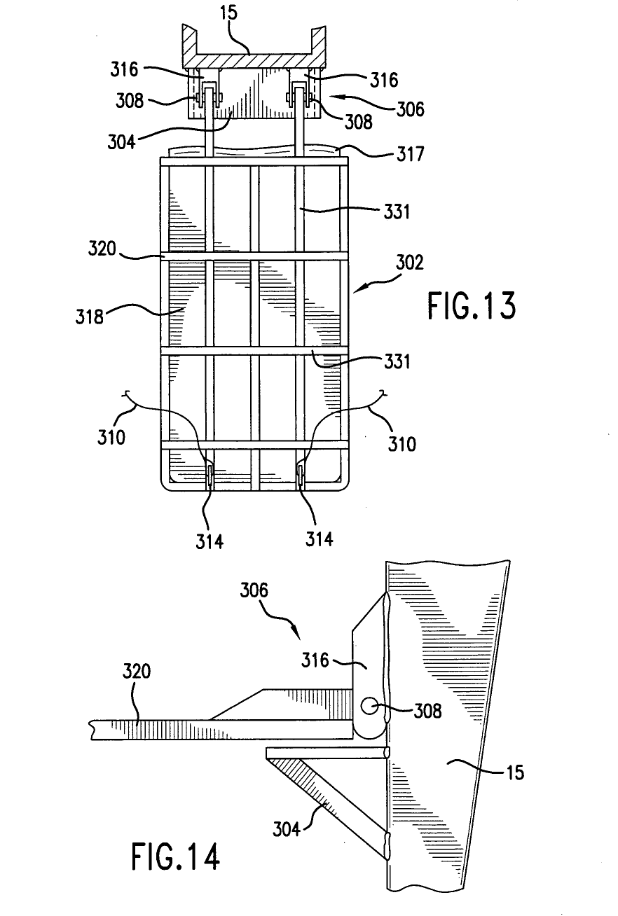

The hinge 306 used to provide pivotal attachment of the guard 302 to the arm 15 may be seen in more detail in FIGS. 13 and 14. Here, the hinge 306 is made from a pair of clevises 316 that are each rigidly attached to the arm 15. In one exemplary embodiment, they may be welded onto the arm 15. Alternatively the clevises 316 can be attached to the arm 15 with mechanical fasteners such as bolts and nuts. The guard 302 includes a frame support 320 that extends into each of the clevises 316 and is pivotally retained thereon by a pair of pivot pins 308. Although shown as employing a pair of clevises 316, it is to be understood that in accordance with other exemplary embodiments of the present invention that more or fewer of the clevises 316 may be used in order to effect pivotal attachment of the guard 302.

The support frame 320 incorporated into the guard 302 may include a steel structure, for instance tubular steel, that includes a series of crisscrossing members 331 forming a shallow cage that is open at the bottom and at the front end, which is nearest the hinge 306. Guard 302 also desirably includes an elastomeric dampener 318 that lines the interior of the cage 320. A plurality of side frame pieces 333 (FIG. 11) may be employed in order to form a structure which provides strength to the support frame 320, forms an enclosure preventing objects 28 from escaping the inlet opening 11, and allows for attachment of the elastomeric dampener 318. The objects 28 (FIG. 12) may be retained by a combination of the support frame 320 and the elastomeric dampener 318. However, other configurations of the guard 302 are possible in accordance with the present invention. For instance, the guard 302 may be a single piece which is in the shape of a plate or a plate having side walls, and may be made of either a single rigid material or a single flexible material. As such, various constructions of the guard 302 are possible in accordance with other exemplary embodiments of the present invention.

In one exemplary embodiment of the present invention, the support frame 320 may be made from tubular steel that is welded together to form a framework that outlines the elastomeric dampener 318. The elastomeric dampener 318 may be rubber that is both pliable and durable, and may be either glued or bolted onto the support frame 320. The elastomeric dampener 318 and possibly the support frame 320 may be somewhat flexible such that they momentarily take the shape of objects 28 (FIG. 12) that contact the guard 302. The elastomeric dampener 318 may be made of natural gum rubber and may have, for instance, a durometer value of forty.

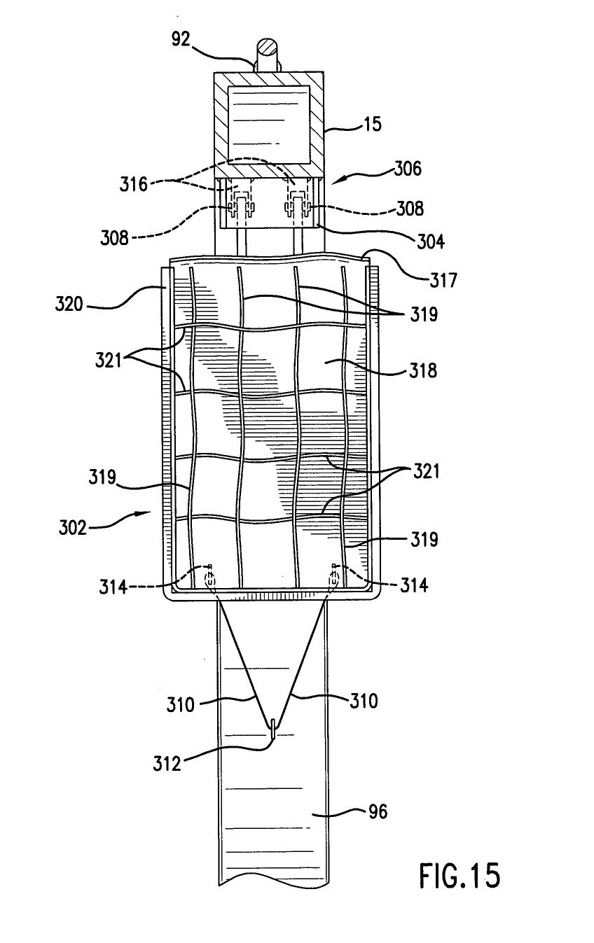

FIG. 15 is taken along line 15-15 of FIG. 11 and shows the guard 302. Here, the elastomeric dampener 318 may be composed of multiple hanging curtains 319 that run lengthwise within cage 320. Dampener 318 also can include a plurality of hanging cross-curtains 321 that are designed widthwise within cage 320 and intersect curtains 319 so that curtains 319 and cross-curtains 321 crisscross one another within the guard 302. An advantage of this configuration is that the cross-curtains 321 can absorb a higher amount of force from propelled objects 28 due to lengthwise impacting on the cross-curtains 321, and due to strength added from their crisscross configuration. As shown in FIG. 12 for example, dampener 318 includes a base 322 that rests against and closes off the top of cage 320, and curtains 319 and cross-curtains 321 depend from base 322. As shown in FIGS. 11 and 12, a front flap 317 of the dampener 318 hangs down in front of the front end of the guard 302. As such, the guard 302 defines an open side nearest to the arm 15. This open side is advantageous in that objects 28 are more easily retained by the guard 302 since the frame 14 may be more snuggly fit into the guard 302 since the open face allows for such insertion. However, the present invention is not limited to a specific configuration of the elastomeric dampener 318, and various shapes may be employed in other exemplary embodiments.

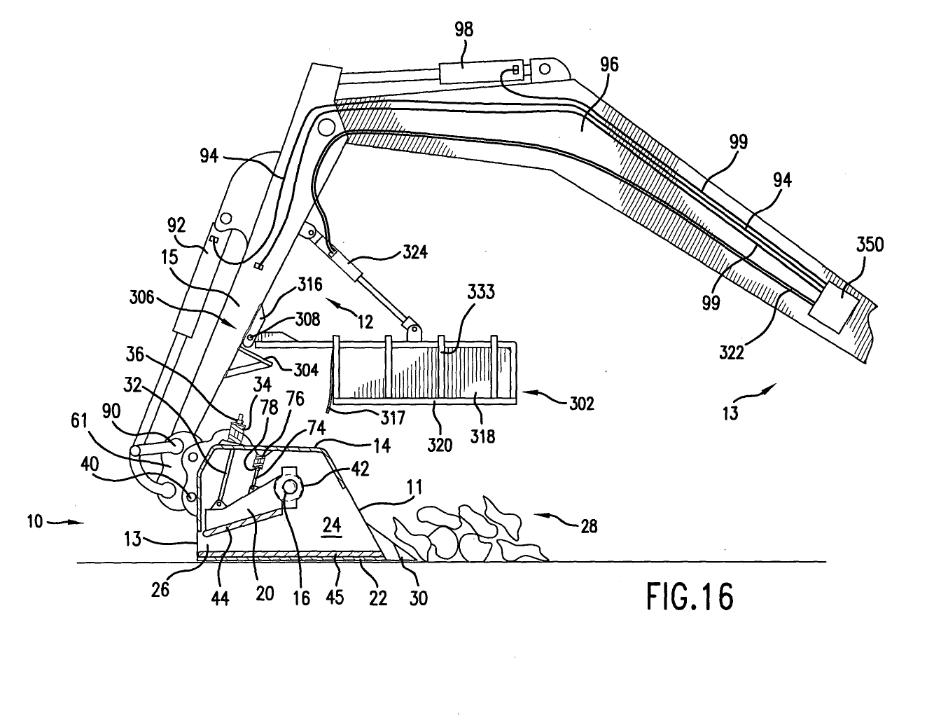

As can be seen in FIG. 15, the guard 302 employs a cable 310. Alternatively, a pair of cables 310 may be used in place of the single cable 310 that is run through an opening in a vehicle cable connection member 312. Each of the cables 310 (or cable 310 if one is used) is pivotally attached to the arm 15 by the vehicle cable connection member 312, which in one exemplary embodiment may be welded onto the arm 15. As shown in FIG. 13, the cables 310 are pivotally attached to the guard 302 by a pair of guard cable connection members 314. The guard cable connection members 314 may be spaced from one another in order to provide desired stability of the guard 302. However, it is to be understood that in other exemplary embodiments of the present invention, that more or fewer (or none at all) than two guard cable connection members 314 may be used, along with variations of the positioning of the guard cable connection members 314. As shown in FIG. 11, the cable 310 is in tension, and supports one end of the guard 302 when the guard 302 is disposed away from the inlet 11 of the frame 14. Once the arm 15 is rotated into the position shown in FIG. 12, tension is released on the cable 310 and it becomes slack, in which case the guard 302 may be allowed to be pivoted about the hinge 306. As such, in accordance with one exemplary embodiment of the present invention, the guard 302 may be properly positioned without the use of any power source. However, other exemplary embodiments of the present invention exist in which the guard 302 is positioned by an electrical or hydraulic source. FIG. 16 shows one such exemplary embodiment where a hydraulic cylinder 324 is pivotally attached to the arm 15 and the guard 302. The hydraulic cylinder 324 may be powered by a diesel/hydraulic system 350 of the excavator 12, and placed into communication with the diesel/hydraulic system 350 through a hydraulic line 322. Actuation of the hydraulic cylinder 324 will cause the guard 302 to be pivoted about the hinge 306 and positioned at a desired location.

Although shown as being attached to the arm 15, it is to be understood that other configurations of the guard 302 are possible in accordance with the present invention. For instance, the guard 302 may be attached to the frame 14. In this case, the guard 302 may be moved in order to block the inlet opening 11 of the frame 14 by gravity through the configuration of the guard 302, or may be moved by an electric or hydraulic system such as the exemplary embodiment shown in FIG. 16.

The guard 302 may be detached from the excavator 12 by removing the guard 302 at the hinge 306 and at the vehicle cable connection member 312 in order to allow for transportation of the excavator 12, or to mount another attachment onto the arm 15. It is to be understood that the guard 302 and related structure may be used with vehicles 12 other than an excavator, for instance a front-end loader, a shovel, or a crane may be used in other exemplary embodiments.

The present invention also provides for a mobile jaw crusher assembly 10 that includes a dust suppression system as shown in FIG. 17. Here, the dust suppression system includes a water tank 352 that may be mounted on the excavator 12. A water pump 356 may be included that may run off of a power system included with the excavator 12, or may be provided with a small engine that operates the water pump 356. Water may be pumped through a water line 354 located on the arm 15 into a spray jet or jets 350 attached to the frame 14 near the outlet opening 13. During crushing of the objects 28, the dust suppression system may be activated such that water is sprayed out of the spray jet or jets 350 proximate to the outlet opening 54 of the frame 14 in order to cut down on the amount of dust produced by the crushing operation. The dust suppression system may be used apart from the guard 302 discussed above, or may be used in combination with the guard 302 as previously discussed.

It should be understood that the present invention includes various modifications that can be made to the exemplary embodiments of the mobile jaw crusher assembly 10 described herein as come within the scope of the appended claims and their equivalents.

What is claimed is:

1. A mobile jaw crusher assembly for crushing objects, comprising:
a frame configured for attachment to a vehicle capable of moving said mobile jaw crusher assembly and at least partially rotating said mobile jaw crusher assembly;
an eccentric shaft rotationally mounted to said frame;
a driving mechanism configured and disposed for driving said eccentric shaft to rotate said eccentric shaft;
a first crushing member engaging said eccentric shaft and moving in response to rotation of said eccentric shaft;
a second crushing member facing said first crushing member, said first and second crushing members defining a holding chamber for holding objects and defining a crushing chamber for crushing objects; and
a guard configured to be selectively positioned to block an inlet opening of said frame and prevent at least some objects from exiting said frame through said inlet opening of said frame.

2. The mobile jaw crusher assembly of claim 1, wherein said guard has a hinge configured to allow said guard to pivot with respect to the vehicle.

3. The mobile jaw crusher assembly of claim 1, wherein said guard has a support member configured for rigid attachment to the vehicle.

4. The mobile jaw crusher assembly of claim 1, wherein said guard has a support frame that supports an elastomeric dampener, said elastomeric dampener configured for dampening noise associated with the crushing of objects.

5. The mobile jaw crusher assembly of claim 1, wherein said guard has a pair of clevises, each said clevis having a pivot pin configured to allow said guard to pivot with respect to the vehicle.

6. The mobile jaw crusher assembly of claim 1, wherein said guard has at least one cable configured for attachment to the vehicle for supporting said guard when said guard is not blocking said inlet opening of said frame.

7. The mobile jaw crusher assembly of claim 1, wherein said guard has a pair of cables attached thereto, one said cable being connected to each of a pair of guard cable connection members, and wherein said guard has a single vehicle cable connection member attached to said pair of cables and configured for attachment to the vehicle, wherein said cables support said guard.

8. The mobile jaw crusher assembly of claim 7, wherein said pair of cables are one single cable.

9. The mobile jaw crusher assembly of claim 1, wherein said guard has an elastomeric dampener forming a plurality of curtains and cross-curtains arranged in a crisscross configuration.

10. The mobile jaw crusher assembly of claim 1, further comprising a spray jet attached to said frame, said spray jet configured for spraying water proximate to an outlet opening of said frame for suppression of dust brought about by the crushing of objects.

11. The mobile jaw crusher assembly of claim 1, further comprising:
a water tank configured for attachment to the vehicle;
at least one spray jet attached to said frame proximate to an outlet opening of said frame;
a water line placing said water tank into fluid communication with said spray jet; and
a water pump in fluid communication with said water line and configured for forcing water through said water line and out of said spray jet in order to suppress dust brought about by the crushing of objects.

12. The mobile jaw crusher assembly of claim 1, further comprising a hydraulic cylinder configured for attachment to the vehicle and engaging said guard, said hydraulic cylinder configured for selectively positioning said guard to block said inlet opening of said frame.

13. The mobile jaw crusher assembly of claim 1, wherein said guard has a closed top face and three adjacent closed side faces defining a depth of said guard, said guard having an open bottom face for receiving objects therein to be blocked by said guard, said guard having a fourth side face openable by said frame.

14. The mobile jaw crusher assembly of claim 1, wherein said guard is configured for at least momentarily conforming to the shape of objects protruding from said inlet opening of said frame.

15. A mobile jaw crusher assembly for crushing objects, comprising:
a frame configured to be attached to a vehicle, said frame having an inlet opening;
a first crushing member housed in said frame and configured to be moved and at least partially rotated by a vehicle along with said frame;
a second crushing member housed in said frame and facing said first crushing member, said first and second crushing members defining a crushing chamber for crushing objects, said second crushing member configured to be moved and at least partially rotated by the vehicle along with said frame; and
a guard configured to be selectively positioned to block said inlet opening of said frame and prevent at least some objects from exiting said frame through said inlet opening.

16. A mobile jaw crusher assembly of claim 15, wherein said guard has a hinge configured to allow said guard to pivot with respect to the vehicle.

17. The mobile jaw crusher assembly of claim 15, wherein said guard has a support member configured for rigid attachment to the vehicle.

18. The mobile jaw crusher assembly of claim 15, wherein said guard has an elastomeric dampener and defines a support frame that supports said elastomeric dampener.

19. The mobile jaw crusher assembly of claim 15, wherein said guard has a pair of devises, each said clevis having a pivot pin configured to allow said guard to pivot with respect to the vehicle.

20. The mobile jaw crusher assembly of claim 15, wherein said guard has at least one cable configured for attachment to the vehicle for supporting said guard.

21. The mobile jaw crusher assembly of claim 15, wherein said guard has an elastomeric dampener forming a plurality of curtains and cross-curtains arranged in a crisscross configuration.

22. The mobile jaw crusher assembly of claim 15, further comprising a spray jet attached to said frame.

23. The mobile jaw crusher assembly of claim 15, further comprising:
a water tank configured for attachment to the vehicle;
at least one spray jet attached to said frame;
a water line placing said water tank into fluid communication with said spray jet; and
a water pump in fluid communication with said water line and configured for forcing water through said water line and out of said spray jet.

24. The mobile jaw crusher assembly of claim 15, further comprising a hydraulic cylinder engaging said guard and used for selectively positioning said guard.

25. The mobile jaw crusher assembly of claim 15, wherein said guard has a closed top face and three adjacent closed side faces defining a depth of said guard, said guard having an open bottom face for receiving objects therein to be blocked by said guard, said guard having a fourth side face openable by said frame.

26. The mobile jaw crusher assembly of claim 15, wherein said guard is configured for at least momentarily conforming to the shape of objects protruding from said inlet opening of said frame.

27. A mobile jaw crusher assembly for crushing objects, comprising:
a frame configured to be attached to a vehicle;
a first crushing member housed in said frame and configured to be moved and at least partially rotated by a vehicle along with said frame;
a second crushing member housed in said frame and facing said first crushing member, said first and second crushing members defining a crushing chamber for crushing objects, said second crushing member configured to be moved in and at least partially rotated by the vehicle along with said frame; and
at least one spray jet attached to said frame, said spray jet configured for spraying fluid to suppress dust brought about by the crushing of objects.

28. The mobile jaw crusher assembly of claim 27, further comprising:
a water tank configured for attachment to the vehicle;
a water line placing said water tank into fluid communication with said spray jet; and
a water pump in fluid communication with said water line and configured for forcing water through said water line and out of said spray jet.

29. A mobile jaw crusher assembly for crushing objects, comprising:
a vehicle being an excavator and having a source of hydraulic power;
a frame pivotally attached to said excavator and having an inlet opening;
an eccentric shaft rotationally mounted to said frame;
a driving mechanism connected to said eccentric shaft and capable of driving said eccentric shaft in order to rotate said eccentric shaft, said driving mechanism being powered by said source of hydraulic power from said excavator;
a shaft housing engaging said eccentric shaft;
a first crushing member engaging said eccentric shaft through said shaft housing, said first crushing member moving in response to rotation of said eccentric shaft;
a second crushing member facing said first crushing member, said first and second crushing members defining a holding chamber and a crushing chamber;
wherein said excavator is propelled and said fame is pivoted so as to capture objects into said holding area and said cylinder rotates said frame and said lift mechanism lifts said frame, wherein objects in said crushing chamber are crushed by said first and second crushing members and are discharged from said frame into a stock pile of saleable product by a single pass through said holding chamber and said crushing chamber; and
a guard configured to be selectively positioned to block said inlet opening of said frame and prevent at least some objects from exiting said frame through said inlet opening.

30. A mobile jaw crusher assembly for crushing objects, comprising:
a frame having an inlet for objects to enter and an outlet for crushed objects to exit;
an eccentric shaft located within said frame and rotatable with respect to said frame;
a first crushing member disposed within said frame and in communication with said eccentric shaft;
a second crushing member located in said frame and facing said first crushing member toward such that rotation of said eccentric shaft causing cyclic movement of said first crushing member and away from said second crushing member;
a driving mechanism attached to said frame, said driving mechanism rotating said eccentric shaft;
a connection member attached to said frame, said connection member being attached to a vehicle; and
a guard configured to be selectively positioned to block said inlet of said frame and prevent at least some objects from exiting said frame through said inlet.
